(19) United States
(12) Patent Application Publication
(10) Pub. No.: US 2006/0012665 A1
(43) Pub. Date: Jan. 19, 2006

(54) Print media and photo printer

(75) Inventor: Yong-Jun Yoo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/155,650

(22) Filed: Jun. 20, 2005

(30) Foreign Application Priority Data
Jul. 14, 2004 (KR) 2004-0054702

(51) Int. Cl. B41J 17/00

(52) U.S. Cl. 347/215; 347/16

(57) ABSTRACT

A print media and a photo printer with improved print quality are provided. The print media includes a printing area, and a mark area formed at one side of the printing area and having first marks formed at regular intervals in a printing direction. The photo printer can measure an actual travel distance of the print media by detecting the marks formed on one side of the print media. Accordingly, the photo printer enables print timing to be exactly synchronized with the feeding of the print media.

### CROSS-REFERENCE TO RELATED APPLICATIONS

This application claims the benefit under b 35 U.S.C. § 119(a) of Korean Patent Application No. 10-2004-0054702, filed on Jul. 14, 2004, in the Korean Intellectual Property Office, the entire disclosure of which is hereby incorporated by reference.

### BACKGROUND OF THE INVENTION

1. Field of the Invention

The present invention relates to a print media and a photo printer. More particularly, the present invention relates to a print media that has marks formed on one side, and a photo printer that includes means for measuring the distance the print media travels by detecting the marks on the print media.

2. Description of the Related Art

Thermal photo printers can be classified into two types of printer. One type uses paper that responds to heat to show a predetermined color on the paper. The other type uses an ink ribbon which responds to heat and transfers the ink (which is a predetermined color) to a typical sheet of paper. Photo printers using an ink ribbon need to have a driver for driving the ink ribbon, leading to complex structures and high costs. Further, since the ink ribbon is consumable, it must be replaced with a new one periodically, thereby causing high printing costs per sheet.

Referring to FIG. 1, a print media 10, which responds to heat to show a predetermined color, includes a base sheet 11 having a first surface 10a and a second surface 10b on which ink layers of predetermined colors are formed. The ink layers have different colors. For example, layers of yellow Y and magenta M are sequentially stacked on the first surface 10a, and a layer of cyan C is formed on the second surface 10b. It is preferable that the base sheet 11 is made of transparent material. A reflective or transparent layer 13 may be formed on the layer of cyan C. An example of the print media 10 is disclosed in U.S. patent Publication No. 2003-0125206, which is hereby incorporated by reference in its entirety.

A photo printer using the print media 10 employs a thermal printhead (TPH) having heating elements arranged perpendicular to a path of the print media 10 in a horizontal resolution.

FIG. 2 is a diagram illustrating a conventional photo printer. Referring to FIG. 2, the conventional photo printer includes a feed roller 2 for feeding the print media 10, a platen roller 3 for supporting one surface of the print media 10, and a TPH 4 for forming an image on the print media 10 supported by the platen roller 3. An encoder disk wheel 7 is installed on one side of the feed roller 2. An encoder sensor (not shown) detects slits 7a formed on the encoder disk wheel 7 to measure the travel distance, that is, the distance that the print media 10 travels.

Since the encoder disk wheel 7 indirectly measures the travel distance of the print media 10, it is difficult to exactly measure the travel distance due to slippage of the print media 10. Further, the encoder disk wheel, which is relatively large, hinders the manufacturing of a more compact photo printer.

Accordingly, there is a need for a thermal printer with an improved apparatus for measuring the travel distance of a print media.

### SUMMARY OF THE INVENTION

An aspect of the present invention is to solve at least the above problems and/or disadvantages and to provide at least the advantages described below. Accordingly, an aspect of the present invention is to provide a print media and a photo printer which can directly measure a travel distance of the print media.

According to an aspect of the present invention, a print media for a photo printer comprises a printing area and a mark area formed at one side of the printing area. The mark area has first marks at regular intervals in a printing direction.

A printing start mark representing a printing start position may be formed in the mark area.

At least one second mark having a length different in the printing direction from that of the first marks may be formed in the mark area.

The second mark may be longer than that of the first marks in the printing direction, and the printing start position may correspond to a first mark formed after the second mark.

A tear line may be formed between the printing area and the mark area.

The first marks may be formed at a resolution of 100 to 300 dpi in the printing direction.

The print media may further comprise first and second tab areas formed on both end portions of the printing area, respectively.

Tear lines may be formed between the printing area and the first tab area and between the printing area and the second tab area, respectively.

According to another aspect of the present invention, a print media comprises a transparent base sheet, a mark area having first marks formed at regular intervals in a printing direction at one side of the transparent base sheet, and a printing area having layers stacked on both surfaces of the transparent base sheet (at locations other than the mark area). The layers can respond to heat and display predetermined colors.

According to still another aspect of the present invention, a photo printer comprises a thermal printhead applying heat to a print media to display predetermined colors, a feed roller feeding the print media, a feed roller motor driving the feed roller, a mark detecting unit detecting marks that are formed at predetermined intervals in a printing direction at one side of the print media, and a control unit controlling the feed roller motor using signals detected by the mark detecting unit to feed the print media.

The mark detecting unit may be a reflective optical sensor.

The print media may include a transparent base sheet, a mark area having the marks formed on the transparent base sheet, and a printing area having layers that are formed on surfaces of the transparent base sheet (at locations other than the mark area). The layers respond to heat applied by the thermal printhead to display the predetermined colors. The mark detecting unit may be a transparent optical sensor composed of a light emitting unit and a light receiving unit formed over and under the mark area, respectively.

The photo printer may further comprise a puncher forming a tear line between the mark area, where the marks are formed, and the printing area, where printing is done, when the print media is discharged.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a sectional view of a conventional print media;

FIG. 2 is a diagram of a conventional photo printer;

FIG. 3 is a diagram of a photo printer according to an embodiment of the present invention;

FIG. 4 is a plan view of a print media according to an embodiment of the present invention;

FIG. 5 is a diagram illustrating waveforms of detected pulse signals for explaining a method of dividing and using the signals;

FIG. 6 is a schematic plan view illustrating some elements of the photo printer shown in FIG. 3;

FIG. 7 is a schematic side view of the elements shown in FIG. 6;

FIG. 8 is a block diagram of a printing control system of a photo printer according to an embodiment of the present invention;

FIG. 9 is a plan view of a print media according to another embodiment of the present invention;

FIG. 10 is a sectional view of a print media according to still another embodiment of the present invention; and

FIG. 11 is a block diagram of a printing control system of a photo printer according to another embodiment of the present invention.

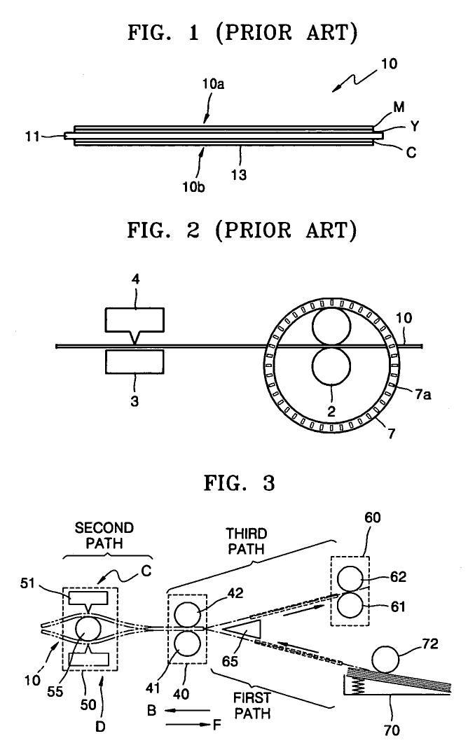

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 3 is a diagram of a photo printer according to an embodiment of the present invention. As shown in FIG. 3, a photo printer includes at least three paths through which a print media 10 is conveyed. The print media 10 is conveyed through the first path to the second path. In the second path, the print media 10 is moved backward in the direction indicated by the arrow B and is moved forward in the direction indicated by the arrow F to print on the print media 10. After printing, the print media 10 goes through the third path. To elaborate, if only the first surface of the print media 10 has been printed on, the print media 10 is returned to the second path from the third path so that the second surface may be printed on. If both the first and second surfaces of the print media 10 have been printed on, the print media 10 is discharged through the third path.

A guide 65 is interposed between the first path and the third path. The guide 65 guides the print media 10 from the first path to the second path, and guides the print media 10 from the second path to the third path. Further, the guide 65 only allows the print media 10 on the second path to be conveyed to the third path. That is, it prevents the print media 10 from being conveyed from the second path to the first path.

An image forming process is performed using an image forming unit 50 in the second path. Before the image forming process is performed on the first and second surface of the print media 10, the positions of a thermal printhead (TPH) 51 and a platen roller 55 of the image forming unit 50 should be determined. For example, if the image forming process is being performed on the first surface of the print media 10, the TPH 51 should be placed at the position C. On the other hand, if the image forming process is being performed on the second surface of the print media 10, the TPH 51 should be placed at the position D. It is preferable that the position change of the TPH 51 be accomplished by rotating the platen roller 55 and the TPH 51 about an axis of the platen roller 55. The position change of the TPH 51 is made when there is no interference between the TPH 51 and the print media 10, such as before the print media 10 is supplied from the first path to the second path or before the print media 10 that has been conveyed to the third path after printing on the first surface is returned to the second path.

If the print media 10 having a printed first surface is fed back to the second path, an image forming process is performed on the second surface of the print media 10 by the TPH 51 whose position has been changed to position D. During the process, the print media is gradually moved by a conveying unit 40. After the second surface is completely printed, the print media 10 is discharged through a print media discharging unit 60. The conveying unit 40 includes a feed roller 41 for feeding the print media 10 and an idle roller 42 for pushing the print media located between the feed roller 41 and the idle roller 42 toward the feed roller 41.

Reference numeral 70 denotes a print media storing unit, and reference numeral 72 denotes a pickup roller for the print media supply.

The print media discharging unit 60 includes a discharging roller 61 and an idle roller 62. The discharging roller 61 and the pickup roller 72 may be disposed so that one roller performs the functions of both rollers 61 and 72.

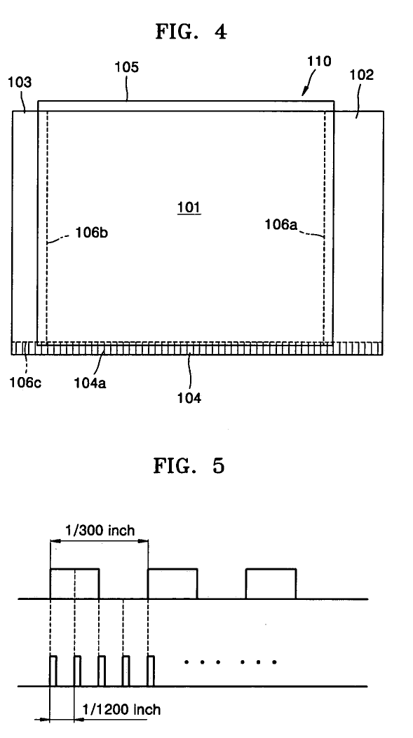

FIG. 4 is a plan view of a print media according to an embodiment of the present invention. Referring to FIG. 4, a print media 110 includes a printing area 101, a top tab area 102 and a bottom tab area 103, which extend from both end portions of the printing area 101, respectively, and a mark area 104, which has marks 104a formed lengthwise at one side of the print media 110 at predetermined regular intervals. When a photo-image is printed on the print media 110, the printed image may be slightly larger than the printing area 101 as shown by box 105 in FIG. 4. After the image is printed, the top tab area 102, the bottom tab area 103, and the mark area 104 are cut off along tear lines 106a, 106b, and 106c to obtain a borderless photo-image.

The print media 110 is available in various standard sizes, for example, 4″×6″, 3″×5″, postcard size, and A6. If the print media 110 is smaller than a printed image, the whole image cannot be printed. Conversely, if the print media 110 is larger than the printed image, a borderless output cannot be obtained.

The marks 104a may be formed at a resolution of 100 to 300 dpi. If the marks 104a are formed at a resolution of 300 dpi, the marks 104a can be used at a resolution of 1200 dpi by dividing a pulse signal, which is generated when the marks 104a are detected by a sensor, into two parts and dividing a space between adjacent pulse signals into two parts (refer to FIG. 5).

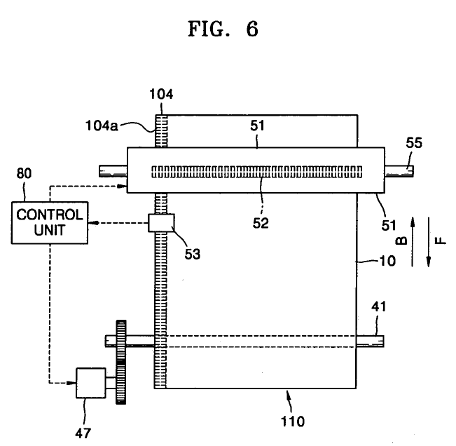

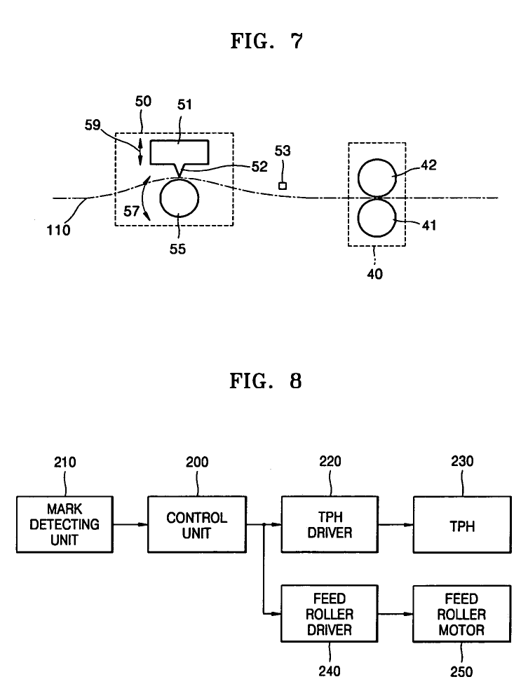

FIG. 6 is a schematic plan view illustrating some elements of the photo printer shown in FIG. 3. FIG. 7 is a schematic sectional view illustrating the elements shown in FIG. 6. Referring to FIGS. 6 and 7, the print media 110 which is gripped between the platen roller 55 and the TPH 51 is moved by the feed roller 41.

The print media 110 is moved by the feed roller 41 in a feedback direction indicated by the arrow B and in a printing direction indicated by the arrow F. A reflective optical sensor 53 is installed above the mark area 104. A light emitting unit of the optical sensor 53 emits light at a predetermined speed, and a light receiving unit of the optical sensor 53 generates pulse signals to detect the marks. A control unit 80 counts the pulse signals to measure the travel distance of the print media 110 that is moved by the feed roller 41, and controls the travel distance of the print media 110 moved by the feed roller 41 by driving a feed roller motor 47. If the number of counted pulse signals from the optical sensor 53 reaches a predetermined number, the control unit 80 outputs a signal for firing heating elements 52 of the TPH 51.

The photo printer includes a rotating unit 57 for rotating the TPH 51 and the platen roller 55 to print on the second surface after the first surface of the print media 110 is printed and a lifting unit 59 for lifting or lowering the TPH 51 a predetermined height above the printing path. When the print media 110 is fed back, the lifting unit 59 lifts the TPH 51 from the platen roller 55 a predetermined distance, for example, 1 to 2 mm, so that the print media 110 can easily pass between the TPH 51 and the platen roller 55.

Since the marks 104a formed on the print media 110 are detected using the optical sensor 53 when the print media 110 travels, an actual travel distance of the print media 110 can be measured.

FIG. 8 is a block diagram of a printing control system of a photo printer according to an embodiment of the present invention. Referring to FIG. 8, the printing control system includes a control unit 200, a mark detecting unit 210, a TPH driver 220, a TPH 230, a feed roller driver 240, and a feed roller motor 250.

The mark detecting unit 210 detects marks formed at one side of a print media and outputs detecting signals to the control unit 200.

The control unit 200 drives the feed roller driver 240 and controls the feed roller motor 250 in response to the detecting signals output from the mark detecting unit 210. Further, if the number of accumulated detecting signals reaches a predetermined number, the control unit 200 drives the TPH driver 220 and transmits a driving signal to the TPH 230 so that the TPH 230 can apply heat to the print media. That is, the control unit 200 counts the number of pulses output from the mark detecting unit 210, and synchronizes and controls the TPH 230 and the feed roller motor 250.

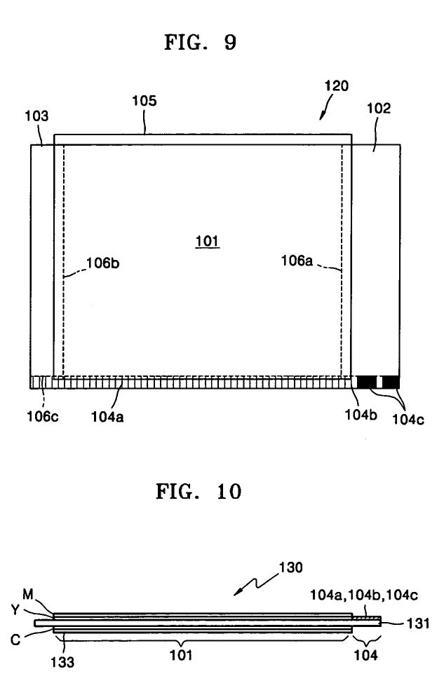

FIG. 9 is a plan view of a print media 120 according to another embodiment of the present invention. The elements which are the same as in the previously described embodiment are given the same reference numerals, and a detailed explanation of those elements is not repeated for clarity and conciseness.

Referring to FIG. 9, two marks 104c longer than the marks 104a are formed in the top tab area 102 that extends from the printing area 101. In FIG. 9, the time when a first mark 104b after the two marks 104c is detected by the optical sensor 53 can be set to the printing start position. Consequently, the print media 120 can easily detect the printing start position, and accordingly, the printing start positions on the first and second surfaces can be aligned. The other effects and functions of the print media 120 are the same as those of the print media 110 according to the previous embodiment illustrated in FIG. 4, and therefore, a detailed explanation is not repeated.

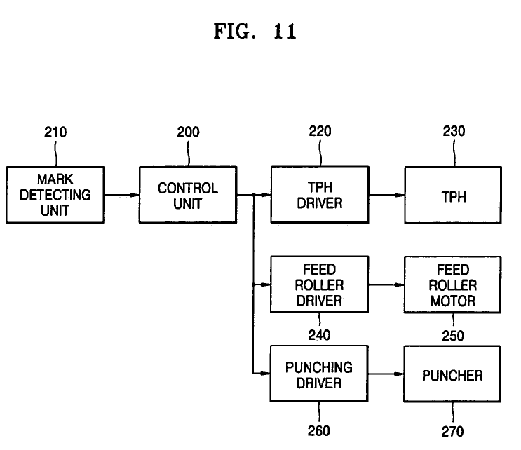

FIG. 10 is a sectional view of a print media according to still another embodiment of the present invention. The elements which are the same as in the previously described embodiment are given the same reference numerals, and a detailed explanation of those elements is not repeated for clarity and conciseness.

Referring to FIG. 10, a print media 130 includes a transparent base sheet 131, a mark area 104 having marks 104a, 104b, and 104c formed at one side of the transparent base sheet 131, and a printing area 101 having layers M, Y, and C stacked on both surfaces of the transparent base sheet 131. The layers M, Y, and C respond to heat and display magenta M, yellow Y, and cyan C colors. The marks 104a, 104b, and 104c may perform the same functions as described in the previous embodiments illustrated in FIGS. 4 and 9.

FIG. 11 is a block diagram of a printing control system of a photo printer according to another embodiment of the present invention. The elements which are the same as in the previously described embodiment are given the same reference numerals, and a detailed explanation of those elements is not repeated for clarity and conciseness.

Referring to FIG. 11, the printing control system of the photo printer includes a control unit 200, a mark detecting unit 210, a TPH driver 220, a TPH 230, a feed roller driver 240, a feed roller motor 250, a punching driver 260, and a puncher 270.

When printing is completed and a print media is discharged, the control unit 200 drives the punching driver 260 so that the puncher 270 can periodically punch a printing area adjacent to a mark area of the print media discharged to the puncher 270 to form tear lines of the print media, for example, the tear line 106c shown in FIG. 4. Accordingly, even though the tear line 106c is not formed previously, such as on the print media 110, 120, and 130 of the previous embodiments, the tear line 106c can be formed later using the puncher 270.

Furthermore, if marks are formed on a transparent base sheet 131 as shown in the print media 130 of FIG. 10, it is preferable that the mark detecting unit 210 be a transparent optical sensor including a light emitting unit and a light receiving unit that are formed over and under the mark area 104 to face each other.

Although the mark area is formed at one side in the embodiments described above, the present invention is not limited to that configuration. For example, another mark area may be formed on an opposite side of the print media.

As described above, since the photo printer can measure the actual travel distance of the print media by detecting marks formed at one side of the print media, print timing can be exactly synchronized with the feeding of the print media. Moreover, since the printing start positions on the first and second surfaces can be aligned during printing, superior image quality can be achieved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A print media of a photo printer, the print media comprising:
a printing area; and
a mark area formed at one side of the printing area and having first marks at regular intervals in a printing direction.

2. The print media of claim 1, wherein
a printing start mark representing a printing start position is formed in the mark area.

3. The print media of claim 2, wherein
at least one second mark having a length different in the printing direction from that of the first marks is formed in the mark area.

4. The print media of claim 3, wherein
the second mark is longer than that of the first marks in the printing direction, and the printing start position corresponds to a first mark formed after the second mark.

5. The print media of one of claim 1, wherein
a tear line is formed between the printing area and the mark area.

6. The print media of claim 1, wherein
the first marks are formed at a resolution of 100 to 300 dpi in the printing direction.

7. The print media of claim 1, further comprising:
first and second tab areas formed on both end portions of the printing area, respectively.

8. The print media of claim 7, wherein
tear lines are formed between the printing area and the first tab area and between the printing area and the second tab area, respectively.

9. A print media of a photo printer, the print media comprising:
a transparent base sheet;
a mark area having first marks formed at regular intervals in a printing direction at one side of the transparent base sheet; and
a printing area having layers stacked on both surfaces of the transparent base sheet other than the mark area so that the layers can respond to heat and display predetermined colors.

10. The print media of claim 9, wherein
a printing start mark representing a printing start position is formed in the mark area.

11. The print media of claim 10, wherein
at least one mark having a length different in the printing direction from that of the first marks is formed in the mark area.

12. The print media of claim 11, wherein
the second mark is longer than that of the first marks in the printing direction, and the printing start position corresponds to a first mark formed after the second mark.

13. The print media of one of claim 9, wherein
a tear line is formed between the printing area and the mark area to divide them.

14. The print media of claim 9, further comprising:
first and second tab areas formed on both end portions of the printing area, respectively.

15. The print media of claim 14, wherein
tear lines are formed between the printing area and the first tab area and between the printing area and the second tab area, respectively.

16. The print media of claim 9, wherein
the first marks are formed at a resolution of 100 to 300 dpi in the printing direction.

17. A photo printer comprising:
a thermal printhead applying heat to a print media to display predetermined colors;
a feed roller feeding the print media;
a feed roller motor driving the feed roller;
a mark detecting unit detecting marks that are formed at predetermined intervals in a printing direction at one side of the print media; and
a control unit controlling the feed roller motor using signals detected by the mark detecting unit to feed the print media.

18. The photo printer of claim 17, wherein
the mark detecting unit is a reflective optical sensor.

19. The photo printer of claim 17, wherein
the print media includes a transparent base sheet, a mark area having the marks formed on the transparent base sheet, and a printing area having layers that are formed on surfaces of the transparent base sheet other than the mark area and the layers respond to heat applied to the thermal printhead to display the predetermined colors, and the mark detecting unit is a transparent optical sensor composed of a light emitting unit and a light receiving unit formed over and under the mark area, respectively.

20. The photo printer of claim 17, further comprising:
a puncher forming a tear line between the mark area, on which the marks are formed, and the printing area, on which printing is done, when the print media is discharged.
